(19) United States
(12) Patent Application Publication
(10) Pub. No.: US 2021/0241332 A1
(43) Pub. Date: Aug. 5, 2021

(54) COMPUTERIZED SYSTEMS AND METHODS FOR INTELLIGENT SELECTION OF AVAILABLE SELLERS AND ASSOCIATED USER INTERFACE MODIFICATION.

(71) Applicant: Coupang Corp., Seoul (KR)

(72) Inventors: Daniel Garrett Rawson, Seoul (KR); Seong Moon Jeong, Seoul (KR)

(73) Assignee: Coupang Corp.

(21) Appl. No.: 16/782,330

(22) Filed: Feb. 5, 2020

(51) Int. Cl. G06Q 30/06; G06Q 10/08; G06Q 30/02; G06F 16/9535; G06F 16/958; G06F 16/2457

(52) U.S. Cl. CPC G06Q 30/0605; G06Q 10/0838; G06Q 30/0282; G06F 3/0484; G06F 16/9535; G06F 16/958; G06F 16/24578; G06Q 30/0641

(57) ABSTRACT

Systems and methods are provided for determining seller scores and modifying webpage displays according to the determined seller scores. One method comprises receiving, from a user device over a network, a selection of a webpage associated with a product; searching a database using the received selection to determine a list of sellers of the product; determining a seller score of each seller of the list based on first, second, and third factors of each seller; and ranking the sellers of the list based on the seller score of each seller. The method may further comprise modifying a user interface element to include product information of the product of the seller with the highest seller score; retrieving a webpage associated with the product and modifying the webpage to include the modified user interface element; and sending, over the network, the modified webpage to the user device.

### TECHNICAL FIELD

The present disclosure generally relates to computerized systems and methods for determining seller scores and modifying webpage displays according to the determined seller scores. In particular, embodiments of the present disclosure relate to inventive and unconventional systems relate to receiving a selection by a user of a webpage associated with a product, determining a seller score of each seller of the associated product, and modifying a webpage associated with the product to include the list of associated sellers ranked from highest to lowest seller score.

### BACKGROUND

Consumers often shop for and purchase various items online through computers and smart devices. However, the normal online shopping experience is limited in that the suggested seller for a particular item is not always the “best” seller.

For example, when a consumer chooses a product to purchase on a webpage, the webpage may automatically suggest the seller who is selling the product for the lowest price. However, the seller with the lowest price is often not the “best” seller. For example, the webpage may determine that the seller with the lowest price is the best seller for a product while failing to consider the seller's low rate of on-time deliveries or low rate of fulfilled orders. A consumer's user experience is severely reduced when their orders are late or unfulfilled, regardless of the product's price. Furthermore, manually searching through each seller's history and product reviews is often difficult and time-consuming for the consumer. A consumer's user experience would be significantly improved if the webpage automatically provided a selection of the best sellers, the selection based on the sellers' history (e.g., number of on-time orders, number of fulfilled orders, etc.), to the consumer.

Therefore, there is a need for improved systems and methods for determining the best sellers for each product and modifying webpage displays so that a list of the best sellers for a product is provided to consumers.

### SUMMARY

One aspect of the present disclosure is directed to a system for webpage display modification. The system may comprise at least one processor; and at least one non-transitory storage medium comprising instructions that, when executed by the at least one processor, cause the at least one processor to perform steps. The steps may comprise receiving, from a user device over a network, a selection of a webpage associated with a product; searching a database using the received selection to determine a list of sellers of the product; determining a seller score of each seller of the list based on first, second, and third factors of each seller; ranking the sellers of the list based on the seller score of each seller; modifying a user interface element to include product information of the product of the seller with the highest seller score; retrieving a webpage associated with the product and modifying the webpage to include the modified user interface element; and sending, over the network, the modified webpage to the user device.

Another aspect of the present disclosure is directed to a method for a webpage display modification. The method may comprise receiving, from a user device over a network, a selection of a webpage associated with a product; searching a database using the received selection to determine a list of sellers of the product; determining a seller score of each seller of the list based on first, second, and third factors of each seller; ranking the sellers of the list based on the seller score of each seller; modifying a user interface element to include product information of the product of the seller with the highest seller score; retrieving a webpage associated with the product and modifying the webpage to include the modified user interface element; and sending, over the network, the modified webpage to the user device.

Yet another aspect of the present disclosure is directed to a system for webpage display modification. The system may comprise at least one processor; and at least one non-transitory storage medium comprising instructions that, when executed by the at least one processor, cause the at least one processor to perform steps. The steps may comprise receiving, from a user device over a network, a selection of a webpage associated with a product; searching a database using the received selection to determine a list of sellers of the product; determining a seller score of each seller of the list based on first, second, and third factors of each seller; determining that one of the first factor, the second factor, the third factor, or the seller score, associated with a first seller, fails to meet a threshold score; modifying the database to remove the first seller from the list of sellers of the product; notifying the first seller that one of the first factor, the second factor, the third factor, or the seller score fails to meet the threshold score ranking the sellers of the list based on the seller score of each seller; modifying a user interface element to include product information of the product of the seller with the highest seller score; retrieving a webpage associated with the product and modifying the webpage to include the modified user interface element; and sending, over the network, the modified webpage to the user device.

Other systems, methods, and computer-readable media are also discussed herein.

### BRIEF DESCRIPTION OF THE DRAWINGS

FIG. 1 A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 depicts an exemplary network of devices and systems for determining seller scores and modifying webpage displays according to the determined seller scores, consistent with the disclosed embodiments.

FIG. 4 depicts a sample seller listing page that includes product information associated with each seller of a list of sellers, consistent with the disclosed embodiments.

FIG. 5 depicts a sample seller portal page that includes seller score information associated with a seller, consistent with the disclosed embodiments.

FIG. 6 depicts a process for determining seller scores and modifying webpage displays according to the determined seller scores, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for determining seller scores and modifying webpage displays according to the determined seller scores. The disclosed embodiments are advantageously capable of modifying webpage displays based on a user's webpage selection. For example, a user may select a webpage associated with a product via a user device. A seller-product system may receive the user's selection via a network and search a database to determine a list of sellers associated with the product. The seller-product system may then send the list of sellers to a seller score system via the network. The seller score system may determine a seller score of each seller of the list based on first, second, and third factors (e.g., order fulfillment, on-time delivery, replies within 24 hours, etc.) of each seller.

In one implementation, the seller score system may submit at least one request for and receive information from a shipment authority technology system. For example, the seller score system may receive information of each seller, including a seller's order delivery status (e.g., whether an order is past its PDD, non-delivered, etc.) from the shipment authority technology system. The seller score system may calculate a seller score of each seller using the information received from the shipment authority technology system. The seller score system may rank the sellers of a list based on the seller score determined for each seller. The seller score system may then modify a user interface element to include product information (e.g., price of the product, PDD of the product, name of the seller, etc.) of the product of the seller with the highest seller score. The seller score system may also retrieve a webpage associated with the product (e.g., SDP) and modify the webpage to include the modified user interface element.

In other embodiments, the seller score system may automatically determine the seller score of each seller periodically (e.g., every seven days, every thirty days, etc.). The seller score system may also determine that one of the first factor, the second factor, the third factor, or the seller score associated with a seller fails to meet a threshold score (e.g., 85, 75, 50, etc.). The seller score system may suspend the products of the associated seller or suspend the associated seller if any one of the three factors or seller score fall below a predetermined threshold. The seller score system may automatically send a notification via the network to the suspend seller to notify the suspended seller of their suspension status. In another embodiment, the seller-product system may determine that the seller with the highest seller score lacks sufficient stock to fulfill an order associated with the product and determine the next highest seller score associated with a seller that has sufficient stock to fulfill the order and modify the webpage to include the product information (e.g., price of the product, PDD of the product, name of the seller, etc.) of that seller.

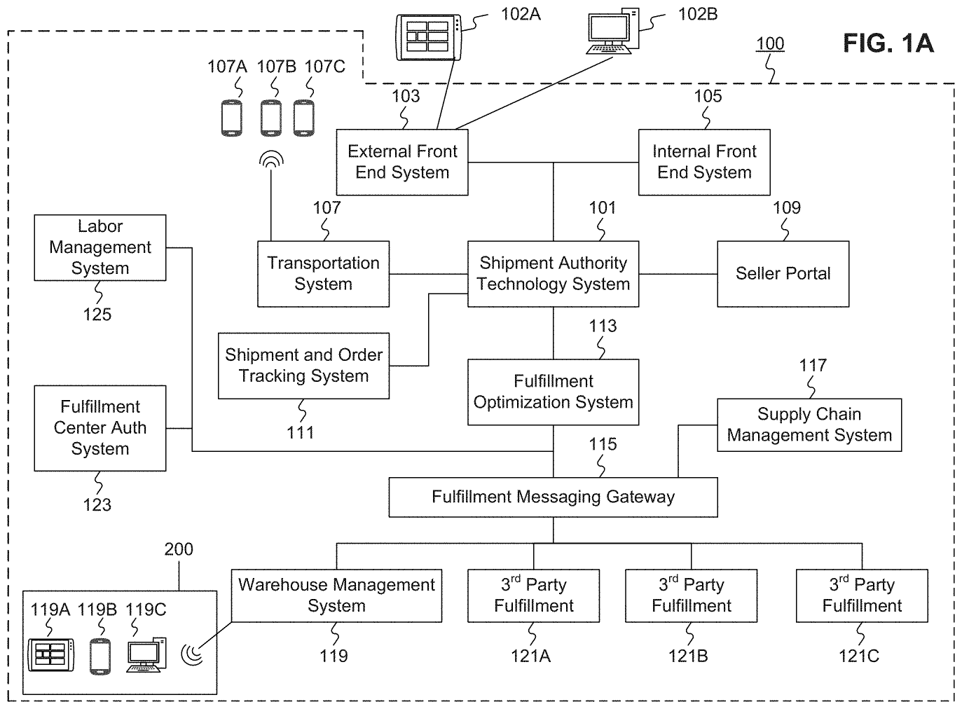

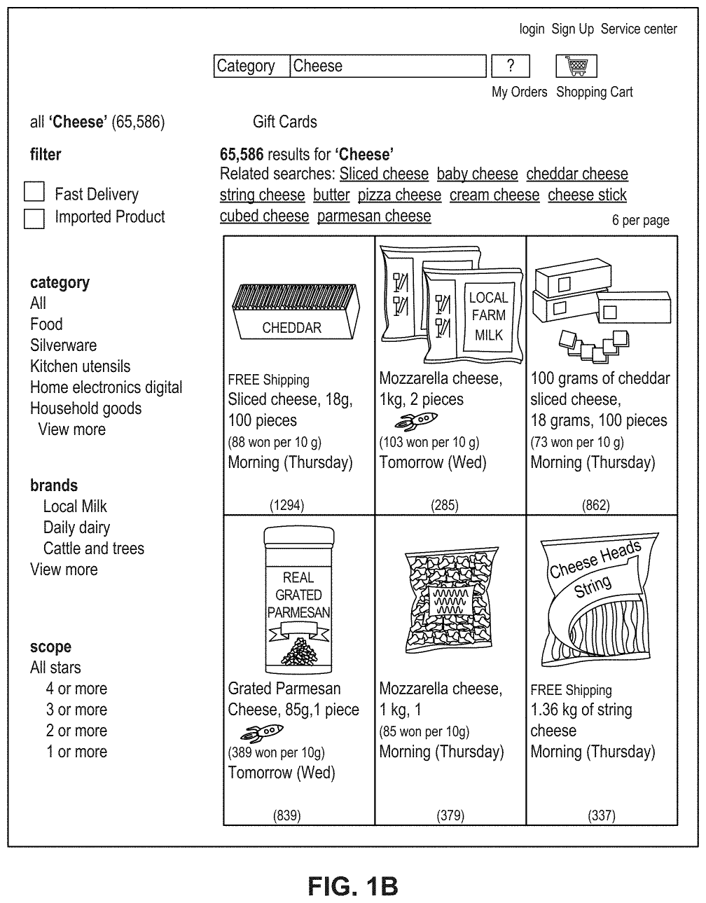

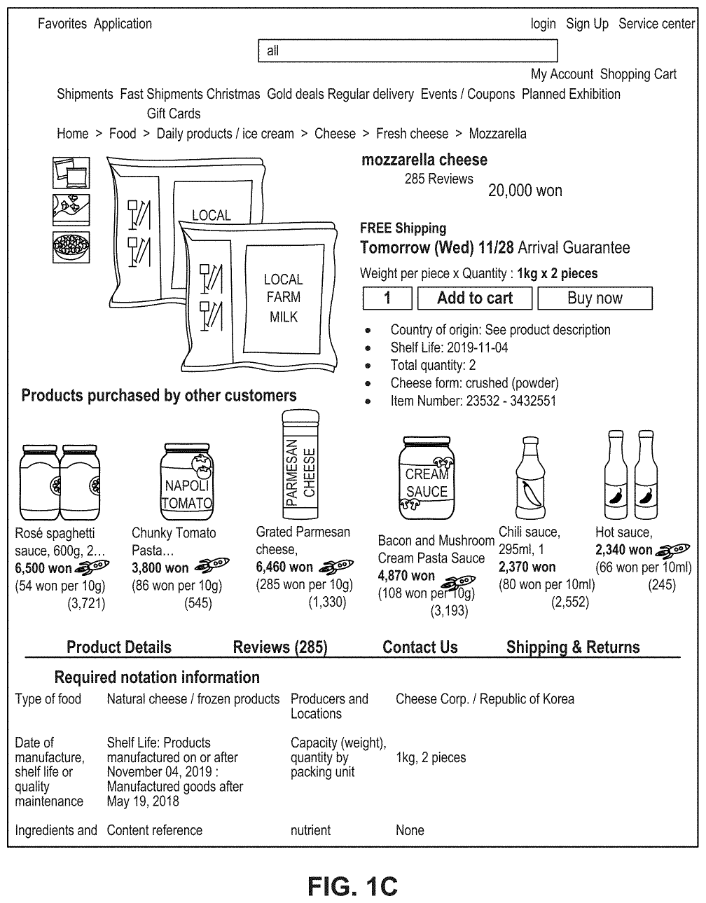

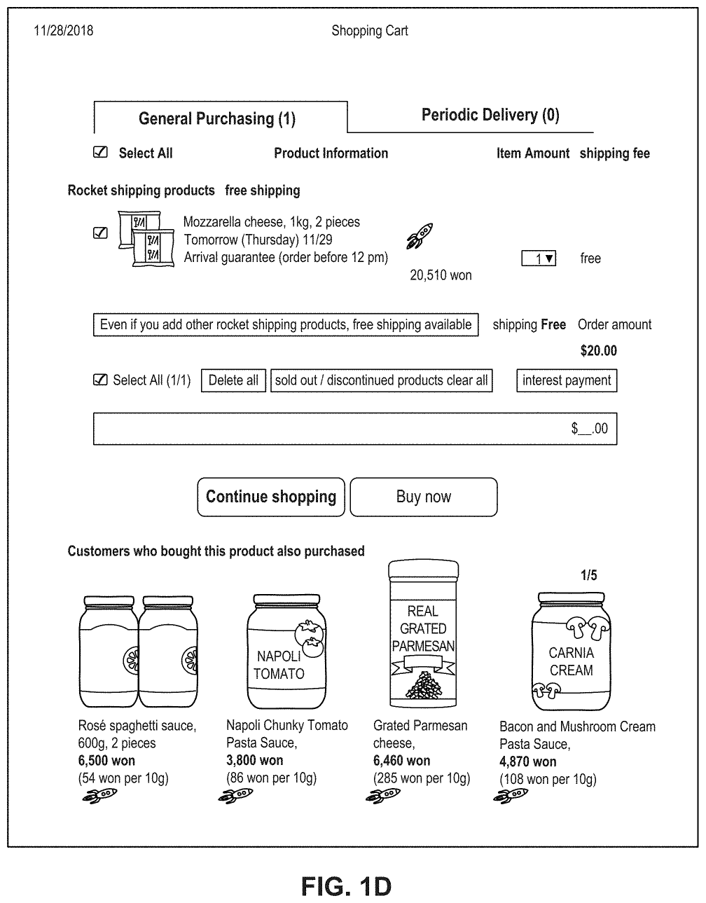

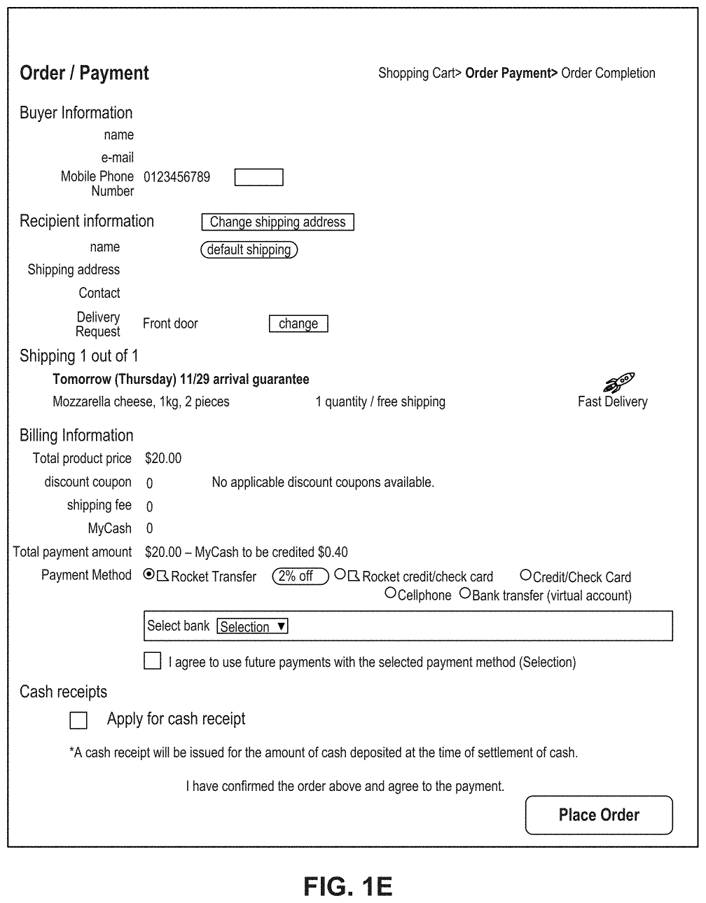

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 1028) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

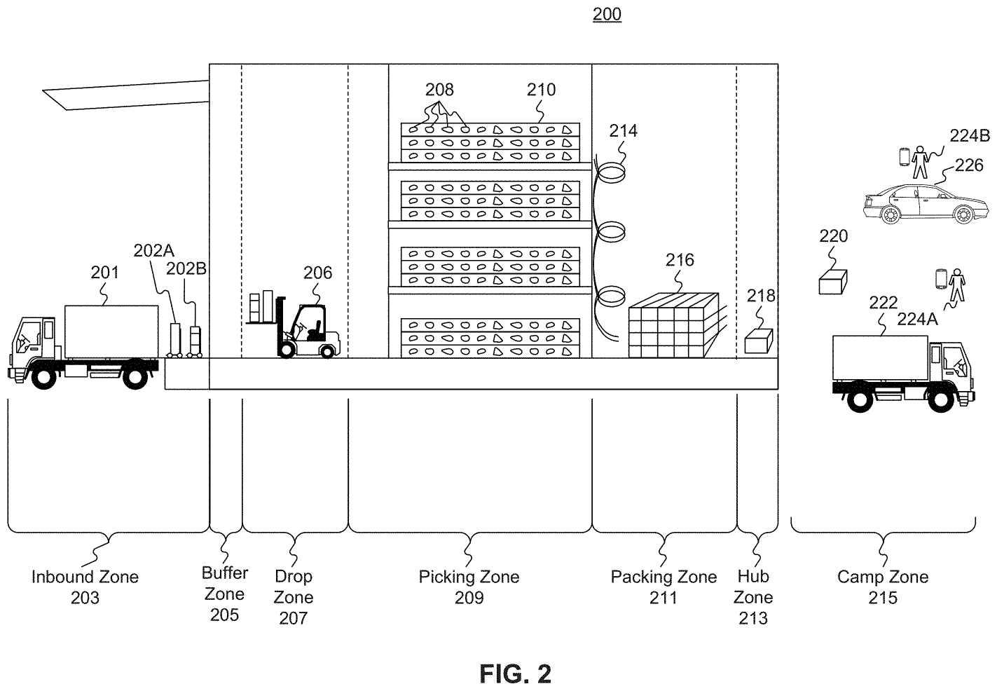

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1 A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

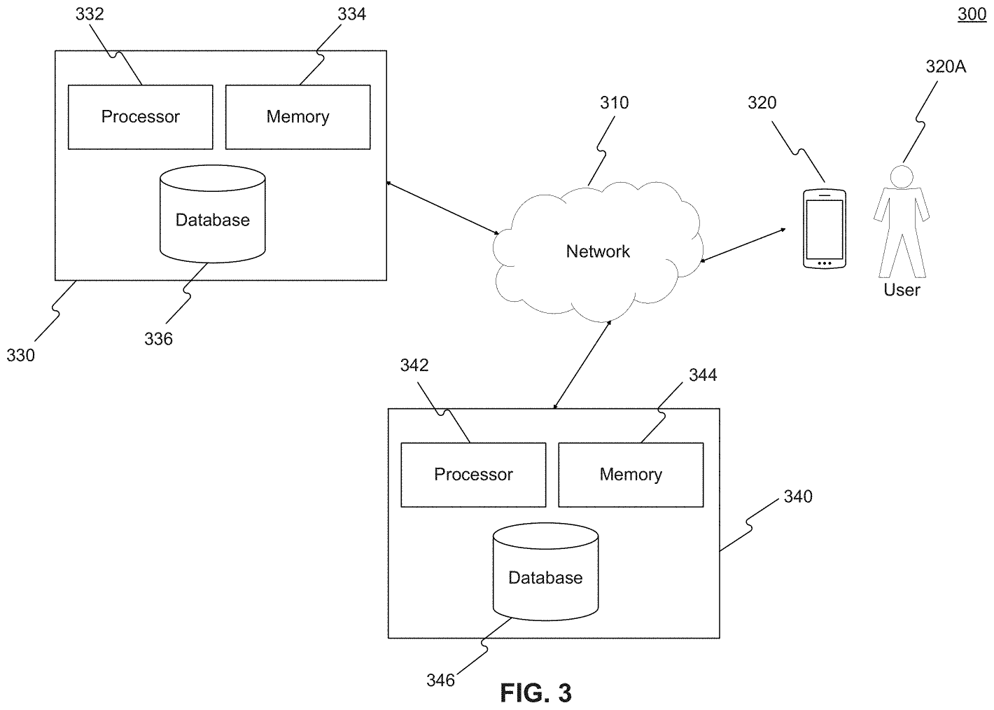

Referring to FIG. 3, an exemplary network of devices and systems for determining seller scores and modifying the webpage displays according to the determined seller scores is shown. As illustrated in FIG. 3, a system 300 may include a seller-product system 330 and a seller score system 340, each of which may communicate with a user device 320 associated with a user 320A via a network 310. In some embodiments, seller score system 340 may communicate with the other components of system 300 via a direct connection, for example, using a cable. In some other embodiments, system 300 may be a part of system 100 of FIG. 1 A and may communicate with the other components of system 100 via network 310 or via a direct connection, for example, using a cable. Seller-product system 330 and seller score system 340 may each comprise a single computer or may each be configured as a distributed computer system including multiple computers that interoperate to perform one or more of the processes and functionalities associated with the disclosed examples.

As shown in FIG. 3, seller-product system 330 may comprise a processor 332, a memory 334, and a database 336. Seller score system 340 may comprise a processor 342, a memory 344, and a database 346. Processors 332 and 342 may be one or more known processing devices, such as a microprocessor from the Pentium™ family manufactured by InteI™ or the Turion™ family manufactured by AMD™. Processors 332 and 342 may constitute a single core or multiple core processor that executes parallel processes simultaneously. For example, processors 332 and 342 may use logical processors to simultaneously execute and control multiple processes. Processors 332 and 342 may implement virtual machine technologies or other known technologies to provide the ability to execute, control, run, manipulate, store, etc. multiple software processes, applications, programs, etc. In another example, processors 332 and 342 may include a multiple-core processor arrangement configured to provide parallel processing functionalities to allow seller-product system 330 and seller score system 340 to execute multiple processes simultaneously. One of ordinary skill in the art would understand that other types of processor arrangements could be implemented that provide for the capabilities disclosed herein.

Memories 334 and 344 may store one or more operating systems that perform known operating system functions when executed by processors 332 and 342, respectively. By way of example, the operating system may include Microsoft Windows, Unix, Linux, Android, Mac OS, iOS, or other types of operating systems. Accordingly, examples of the disclosed invention may operate and function with computer systems running any type of operating system. Memories 334 and 344 may be a volatile or non-volatile, magnetic, semiconductor, tape, optical, removable, non-removable, or other type of storage device or tangible computer readable medium.

Databases 336 and 346 may include, for example, Oracle™ databases, Sybase™ databases, or other relational databases or non-relational databases, such as Hadoop™ sequence files, HBase™, or Cassandra™. Databases 336 and 346 may include computing components (e.g., database management system, database server, etc.) configured to receive and process requests for data stored in memory devices of the database(s) and to provide data from the database(s). Databases 336 and 346 may include NoSQL databases such as HBase, MongoDB™ or Cassandra™. Alternatively, databases 336 and 346 may include relational databases such as Oracle, MySQL and Microsoft SQL Server. In some embodiments, databases 336 and 346 may take the form of servers, general purpose computers, mainframe computers, or any combination of these components.

Databases 336 and 346 may store data that may be used by processors 332 and 342, respectively, for performing methods and processes associated with disclosed examples. Databases 336 and 346 may be located in seller-product system 330 and seller score system 340, respectively, as shown in FIG. 3, or alternatively, it may be in an external storage device located outside of product system 330 and seller score system 340. Data stored in 336 may include any suitable data associated with sellers and their products (e.g., price, product description, etc. for each seller) and data stored in 346 may include any suitable data associated with each seller's seller score (e.g., calculated seller scores for each seller).

User device 320 may be a tablet, mobile device, computer, or the like. User device 320 may include a display. The display may include, for example, liquid crystal displays (LCD), light emitting diode screens (LED), organic light emitting diode screens (OLED), a touch screen, and other known display devices. The display may show various information to a user. For example, it may display the modified webpage that includes a modified user interface element, which includes product information (e.g., price of the product, PDD of the product, name of the seller, etc.) of the product of the seller with the highest seller score. User device 320 may include one or more input/output (I/O) devices. The I/O devices may include one or more devices that allow user device 320 to send and receive information from user 320A or another device. The I/O devices may include various input/output devices, a camera, a microphone, a keyboard, a mouse-type device, a gesture sensor, an action sensor, a physical button, an oratory input, etc. The I/O devices may also include one or more communication modules (not shown) for sending and receiving information from seller-product system 330 or seller score system 340 by, for example, establishing wired or wireless connectivity between user device 320 and network 310.

User 320A may select a webpage associated with a product via user device 320. Seller-product system 330 may receive the selection of user 320A via network 310. Seller-product system 330 may then search database 336 using the received selection to determine a list of sellers of the associated product. Seller-product system 330 may send the list of sellers to seller score system 340 via network 310.

Seller score system 340 may determine a seller score of each seller of the list based on first, second, and third factors of each seller. Seller score system 340 may submit at least one request for and receive information from SAT system 101. For example, seller score system 340 may receive information of each seller including a seller's order delivery status (e.g., whether an order is past its PDD, non-delivered, etc.) from SAT system 101.

The first factor may be associated with a seller's order fulfillment. The first factor of each seller may be calculated by determining a first base factor associated with a respective seller. Seller score system 340 may then determine a total number of promised packages associated with the respective seller and deduct a number of points proportional to a fraction of the total number of undelivered packages from the first base factor. For example, the first base factor may be 100. If the associated seller did not deliver 30% of their total number of packages, then seller score system 340 may deduct 30 points from 100, resulting in a first factor of 70.

The second factor may be associated with a seller's on-time delivery. The second factor of each seller may be calculated by determining a second base factor associated with a respective seller. Seller score system 340 may then determine a total number of promised packages associated with the respective seller and deduct a number of points proportional to a fraction of the total number of packages not delivered by a PDD from the second base factor. A package may be delivered on-time if the package is delivered to the correct customer on or before the PDD. For example, the second base factor may be 100. If the associated seller did not deliver 40% of their total number of packages by the associated PDDs, then seller score system 340 may deduct 40 points from 100, resulting in a second factor of 60.

The third factor may be associated with a seller's replies within a 24-hour period. As previously described, external front end system 103 enables external users to interact with one or more systems in system 100. For example, external front end system 103 enables users to submit questions or comments on any webpage (e.g., SDP) for any seller. Sellers may respond to questions or comments from users via seller portal 109. Calculating the third factor of each seller may comprise determining a third base factor associated with a respective seller, determining a total number of inquiries associated with the respective seller and posted on the webpage by users for a 24-hour time period, and deducting a number of points proportional to a fraction of the total number of inquiries lacking a response by the respective seller within the 24-hour time period from the third base factor. For example, the third base factor may be 100. If the associated seller did not address or respond to 50% of their total number of inquiries within 24 hours of the submission of the inquiries, then seller score system 340 may deduct 50 points from 100, resulting in a third factor of 50. For example, an inquiry may comprise a question about a feature of a product submitted to the seller by a user.

In some embodiments, seller score system 340 may calculate the seller score by averaging the first, second, and third factors for each seller. For example, if the first, second, and third factors of a seller are 70, 80, and 90, respectively, then the seller score of that seller is 80. However, seller score system 340 may calculate the seller score using other methods of calculations besides averaging the first, second, and third factors. For example, seller score system 340 may calculate the seller score by averaging some of the first, second, or third factors while disregarding the other(s). Seller score system 340 may rank the sellers of the list based on the seller score determined for each seller.

Seller score system 340 may then modify a user interface element of external front end system 103 via network 310 to include product information (e.g., price of the product, PDD of the product, name of the seller, etc.) of the product of the seller with the highest seller score. Seller score system 340 may also retrieve a webpage associated with the product (e.g., SDP) from external front end system 103 and modify the webpage to include the modified user interface element. External front end system 103 may receive the modified webpage from seller score system 340 and send the modified webpage to user device 320 via network 310.

Seller score system 340 may automatically determine the seller score of each seller periodically. For example, seller score system 340 may set a timer, determine that an expiration of the timer is seven days, and determine the seller score associated with each seller at the expiration of the timer (e.g., seven days).

Seller score system 340 may determine that one of a first factor, a second factor, a third factor, or a seller score associated with at least one seller fails to meet a threshold score. For example, the thresholds may be 85, 75, 50, and 75 for the first factor, second factor, third factor, and seller score, respectively. If any one of the three factors or seller score fall below their respective thresholds, seller score system 340 may suspend the products of the associated seller by sending instructions to seller-product system 330 to modify database 336 to remove the suspended seller from the list of sellers of the product. Seller score system 340 may suspend a seller from selling any products if it determines that any one of the three factors or seller score fall below an even lower threshold (e.g., 50). Seller score system 340 may suspend a seller from selling any products by sending instructions to seller-product system 330 to modify database 336 to remove the suspended seller from all lists of products to which the suspended seller belongs. Seller score system 340 may automatically send a notification via network 310 to the suspended seller, notifying the suspended seller of their suspension status.

Seller score system 340 may send the rankings of the sellers of the list to seller-product system 330. Seller-product system 330 may determine that the seller with the highest seller score lacks sufficient stock to fulfill an order associated with the product. Seller-product system 330 may determine that the seller with the next highest seller score has sufficient stock to fulfill the order and modify the user interface element to include product information of the product of that seller. Seller-product system 330 may perform the process described above until it determines the seller with the highest seller score among the sellers that have sufficient stock to fulfill the order.

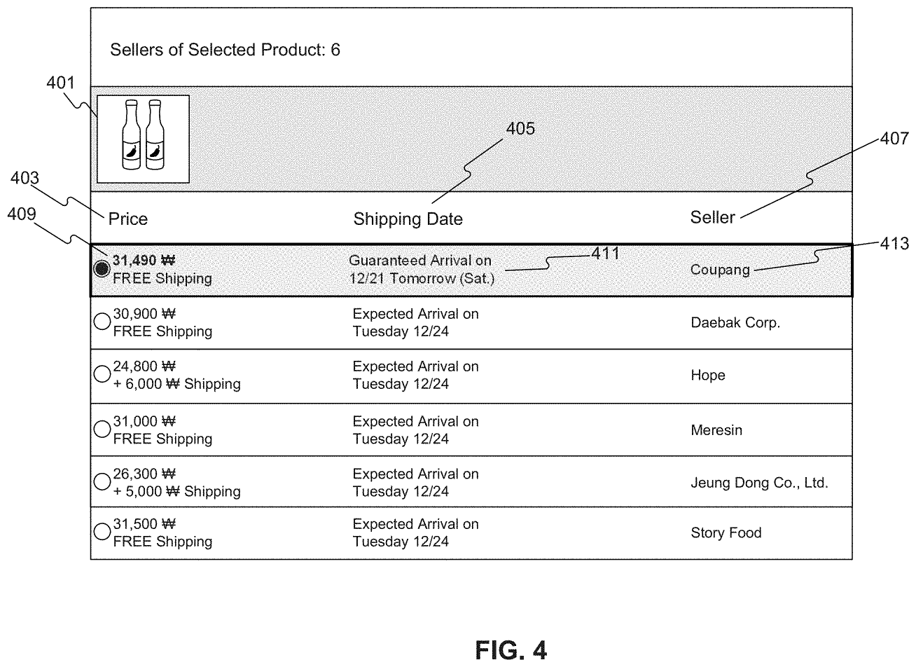

Referring to FIG. 4, a sample seller listing page that includes product information associated with each seller of a list of sellers is shown. User 320A of FIG. 3 may select a product from the SRP via user device 320, e.g., by clicking or tapping a user interface, or using another input device, to select a product represented on the SRP. User device 320A of FIG. 3 may formulate a request for information on the selected product and send it to external front end system 103. In response, external front end system 103 may request information from seller score determination system 300 of FIG. 3 related to the selected product. For example, the information may include additional information beyond that presented for a product on the respective SRP. This could include, for example, a list of sellers ranking in order from highest to lowest seller score, shelf life, country of origin, weight, size, number of items in package, handling instructions, or other information about the product. External front end system 103 may then display the received additional information on the SDP for the product (e.g., FIG. 1C). User 320A may select the list of sellers on the SDP to obtain a display, as shown in FIG. 4, of the list of sellers ranked from highest to lowest seller score and its associated product information.

For example, the sample seller listing page of FIG. 4 shows six sellers for a selected product 401. A column for price 403, a column for shipping date 405, and a column for the seller name 407 are included in the sample seller listing page of FIG. 4. The six sellers shown in FIG. 4 are listed, from top down, in order of highest to lowest seller score. For example, column 403 includes a price 409 of the product offered by the seller with the highest seller score, column 405 includes a shipping date 411 of the product offered by the seller with the highest seller score, and column 407 includes a seller name 413 of the seller of the product offered by the seller with the highest seller score. Although the sample seller listing page of FIG. 4 shows multiple sellers for a selected product, in some embodiments the sample seller listing page may display a single seller by default (e.g., the seller with the highest seller score). In these embodiments, users may have the option to view information associated with the other sellers and select one of those sellers.

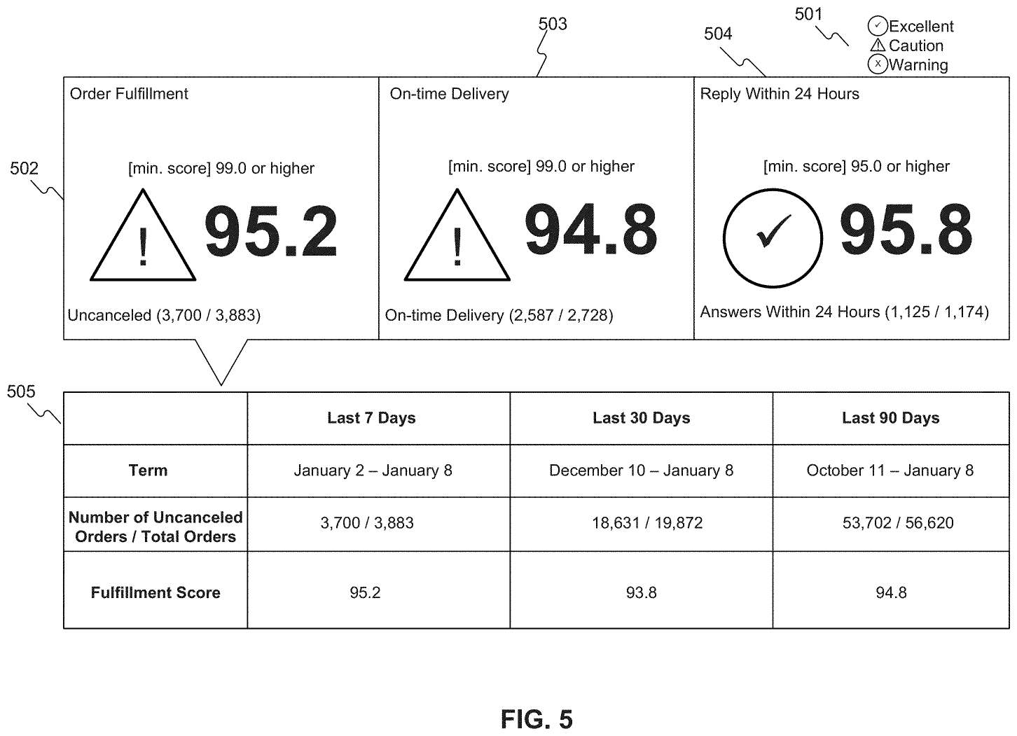

Referring to FIG. 5, a sample seller portal page that includes seller score information associated with a seller is shown. The sample seller portal page may include a key 401 including icons for “excellent,” “caution,” and “warning” ratings. A “warning” rating may indicate that the seller's factor or score fails to meet both minimum thresholds, a “caution” rating may indicate that the seller's factor or score meets the lower threshold but fails to meet the higher threshold, and an “excellent” rating may indicate that the seller's factor or score is above both thresholds. A seller must have “excellent” ratings for all factors in order to have an overall “excellent” seller score. Seller score system 340 of FIG. 3 may automatically or manually send a notification to a seller if the seller has any “caution” ratings without suspending the seller. Seller score system 340 of FIG. 3 may automatically send a notification to a seller and suspend the seller if the seller has any “warning” ratings.

The sample seller portal page may also include a box 502 associated with order fulfillment for a seller, where box 502 includes the seller's order fulfillment score, the minimum score to achieve an “excellent” rating for that category, a number of uncancelled orders, a total number of orders for calculating order fulfillment score. Similarly, the sample seller portal page includes a box 503 associated with on-time deliveries for a seller and a box 504 associated with inquiries answered within 24 hours. The seller may select any one of boxes 502, 503, or 504, which results in a table display 505 for that box. Table display 505 includes detailed information (e.g., details of the orders, products, or inquiries the seller “failed” to fulfill, timely deliver, or address) for the selected box.

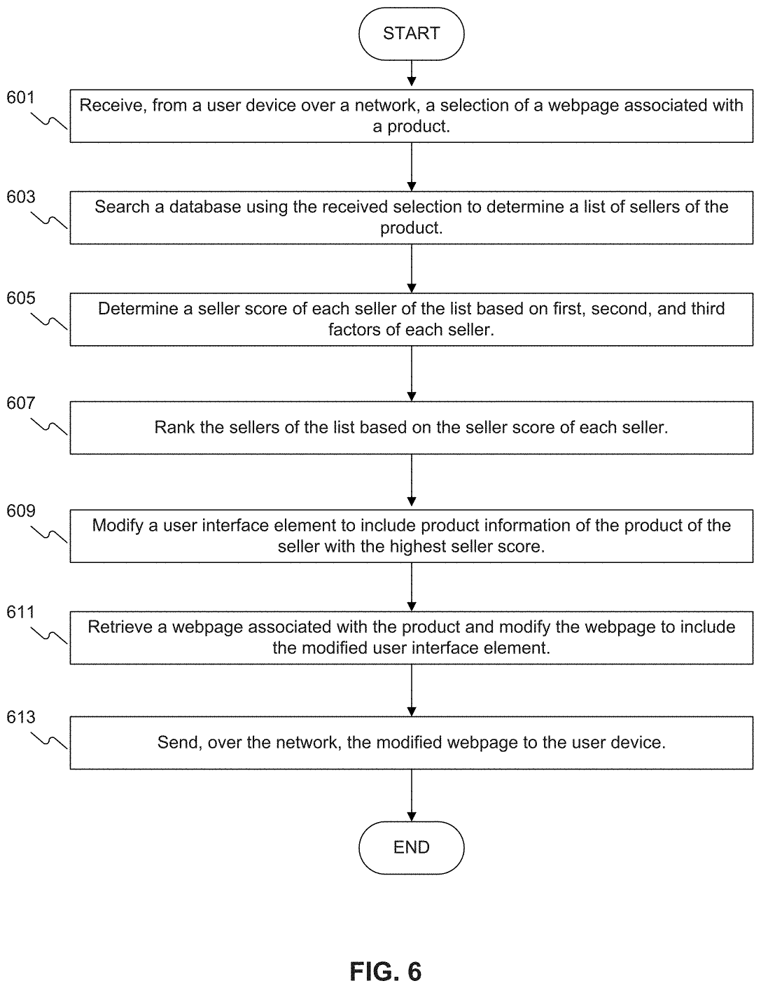

Referring to FIG. 6, a process for determining seller scores and modifying webpage displays according to the determined seller scores is shown. While in some embodiments seller-product system 330 may perform several of the steps described herein, other implementations are possible. For example, any of the systems and components (e.g., system 100, seller score system 340, etc.) described and illustrated herein may perform the steps described in this disclosure.

In step 601, seller-product system 330 may receive, from user 320A over network 310, a selection of a webpage associated with a product. For example, user 320 may select a product from a webpage including a SRP.

In step 603, seller-product system 330 may search database 336 using the received selection to determine a list of sellers of the associated product. Seller-product system 330 may send the list of sellers to seller score system 340 via network 310.

In step 605, seller score system 340 may determine a seller score of each seller of the list based on first, second, and third factors of each seller. Seller score system 340 may submit at least one request for and receive information including the first, second, and third factors of each seller from SAT system 101. The first factor may be associated with a seller's order fulfillment, the second factor may be associated with a seller's on-time delivery, and the third factor may be associated with a seller's replies within a 24-hour period. Seller score system 340 may then calculate the seller score by averaging the first, second, and third factors for each seller. In some embodiments, seller score system 340 may calculate the seller score by averaging some of the first, second, or third factors while disregarding the other(s).

In step 607, seller scores system 340 may rank the sellers of the list from highest to lowest seller score based on the calculated seller scores of each seller.

In step 609, seller score system 340 may modify a user interface element of external front end system 103 via network 310 to include product information (e.g., price of the product, PDD of the product, name of the seller, etc.) of the product of the seller with the highest seller score.

In step 611, seller score system 340 may retrieve a webpage associated with the product (e.g., SDP) from external front end system 103 and modify the webpage to include the modified user interface element.

In step 613, external front end system 103 may receive the modified webpage from seller score system 340 and send the modified webpage to user device 320 via network 310.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computerized system for webpage display modification, comprising:
at least one processor; and
at least one non-transitory storage medium comprising instructions that, when executed by the at least one processor, cause the at least one processor to perform steps comprising:
receiving, from a user device over a network via a user interface, a user selection of a webpage to request information associated with a product;
searching a database using the received selection to determine a list of sellers of the product;
modifying a user interface element to include product information of the product of a seller with a highest seller score, wherein the modification comprises setting a timer, determining an expiration of the timer, and upon the expiration of the timer:
determining a seller score of each seller of the list based on first, second, and third factors of each seller, wherein the first factor is associated with a number of undelivered packages, the second factor is associated with a number of packages not delivered by a promised delivery date, and the third factor is associated with a number of inquiries lacking a response by the respective seller;
ranking the sellers of the list based on the seller score of each seller; and
modifying the user interface element to include a buy now button, wherein the buy now button is configured to initiate a purchase of the product from the seller with the highest selling score;
retrieving a webpage associated with the product and modifying the webpage to include the modified user interface element; and
sending, over the network, the modified webpage to the user device.

2. The system of claim 1, wherein the first factor of each seller is calculated based on operations comprising:
determining a first base factor associated with a respective seller;
determining a total number of promised packages associated with the respective seller; and
deducting a number of points proportional to a fraction of the total number of undelivered packages from the first base factor.

3. The system of claim 1, wherein the second factor of each seller is calculated based on operations comprising:
determining a second base factor associated with a respective seller;
determining a total number of promised packages associated with the respective seller; and
deducting a number of points proportional to a fraction of the total number of packages not delivered by a promised delivery date from the second base factor.

4. The system of claim 1, wherein the third factor is calculated based on operations comprising:
determining a third base factor associated with a respective seller;
determining a total number of inquiries associated with the respective seller and posted on the webpage by users over a time period; and
deducting a number of points proportional to a fraction of the total number of inquiries lacking a response by the respective seller within the time period from the third base factor.

5. The system of claim 1, wherein calculating the seller score comprises averaging the first, second, and third factors.

6. The system of claim 1, wherein the product information comprises a price of the product, a promised delivery date of the product, or a name of the seller.

7. (canceled)

8. The system of claim 1, the steps further comprising:
determining that one of a first factor, a second factor, a third factor, or a seller score, associated with a first seller, fails to meet a threshold score; and
modifying the database to remove the first seller from the list of sellers of the product.

9. The system of claim 1, the steps further comprising:
determining that one of a first factor, a second factor, a third factor, or a seller score, associated with a first seller, fails to meet a threshold score;
searching the database to determine at least one list of at least one product to which the first seller belongs; and
modifying the database to remove the first seller from the at least one list of at least one product.

10. The system of claim 1, the steps further comprising:
determining that a first seller has the highest seller score;
determining that a second seller has a second highest seller score;
determining that the first seller lacks sufficient stock to fulfill an order associated with the product;
determining that the second seller has sufficient stock to fulfill the order; and
modifying the user interface element to include product information of the product of the second seller.

11. A method for webpage display modification, comprising:
receiving, from a user device over a network via a user interface, a user selection of a webpage to request information associated with a product;
searching a database using the received selection to determine a list of sellers of the product;
modifying a user interface element to include product information of the product of a seller with a highest seller score, wherein the modification comprises setting a timer, determining an expiration of the timer, and upon the expiration of the timer:
determining a seller score of each seller of the list based on first, second, and third factors of each seller, wherein the first factor is associated with a number of undelivered packages, the second factor is associated with a number of packages not delivered by a promised delivery date, and the third factor is associated with a number of inquiries lacking a response by the respective seller;
ranking the sellers of the list based on the seller score of each seller; and
modifying the user interface element to include a buy now button, wherein the buy now button is configured to initiate a purchase of the product from the seller with the highest selling score;
retrieving a webpage associated with the product and modifying the webpage to include the modified user interface element; and
sending, over the network, the modified webpage to the user device.

12. The method of claim 11, wherein the first factor of each seller is calculated based on operations comprising:
determining a first base factor associated with a respective seller;
determining a total number of promised packages associated with the respective seller; and
deducting a number of points proportional to a fraction of the total number of undelivered packages from the first base factor.

13. The method of claim 11, wherein the second factor of each seller is calculated based on operations comprising:
determining a second base factor associated with a respective seller;
determining a total number of promised packages associated with the respective seller; and
deducting a number of points proportional to a fraction of the total number of packages not delivered by a promised delivery date from the second base factor.

14. The method of claim 11, wherein the third factor is calculated based on operations comprising:
determining a third base factor associated with a respective seller;
determining a total number of inquiries associated with the respective seller and posted on the webpage by users over a time period; and
deducting a number of points proportional to a fraction of the total number of inquiries lacking a response by the respective seller within the time period from the third base factor.

15. The method of claim 11, wherein calculating the seller score comprises averaging the first, second, and third factors.

16. The method of claim 11, wherein the product information comprises a price of the product, a promised delivery date of the product, or a name of the seller.

17. The method of claim 11, the steps further comprising:
determining that one of a first factor, a second factor, a third factor, or a seller score, associated with a first seller, fails to meet a threshold score; and
modifying the database to remove the first seller from the list of sellers of the product.

18. The method of claim 11, the steps further comprising:
determining that one of a first factor, a second factor, a third factor, or a seller score, associated with a first seller, fails to meet a threshold score;
searching the database to determine at least one list of at least one product to which the first seller belongs; and
modifying the database to remove the first seller from the at least one list of at least one product.

19. The method of claim 11, the steps further comprising:
determining that a first seller has the highest seller score;
determining that a second seller has a second highest seller score;
determining that the first seller lacks sufficient stock to fulfill an order associated with the product;
determining that the second seller has sufficient stock to fulfill the order; and
modifying the user interface element to include product information of the product of the second seller.

20. A computerized system for webpage display modification, comprising:
at least one processor; and
at least one non-transitory storage medium comprising instructions that, when executed by the at least one processor, cause the at least one processor to perform steps comprising:
receiving, from a user device over a network via a user interface, a user selection of a webpage to request information associated with a product;
searching a database using the received selection to determine a list of sellers of the product;
modifying a user interface element to include product information of the product of a seller with a highest seller score, wherein the modification comprises setting a timer, determining an expiration of the timer, and upon the expiration of the timer:
determining a seller score of each seller of the list based on first, second, and third factors of each seller, wherein the first factor is associated with a number of undelivered packages, the second factor is associated with a number of packages not delivered by a promised delivery date, and the third factor is associated with a number of inquiries lacking a response by the respective seller;
determining that one of the first factor, the second factor, the third factor, or the seller score, associated with a first seller, fails to meet a threshold score;
modifying the database to remove the first seller from the list of sellers of the product;
notifying the first seller that one of the first factor, the second factor, the third factor, or the seller score fails to meet the threshold score;
ranking the sellers of the list based on the seller score of each seller; and
modifying the user interface element to include a buy now button, wherein the buy now button is configured to initiate a purchase of the product from the seller with the highest selling score;
retrieving a webpage associated with the product and modifying the webpage to include the modified user interface element; and
sending, over the network, the modified webpage to the user device.
